(19) United States
(12) Patent Application Publication
(10) Pub. No.: US 2018/0089923 A1
(43) Pub. Date: Mar. 29, 2018

(54) SYSTEMS AND METHODS FOR PROMOTING DIGITAL CURRENCY BY REDUCING USE OF COIN CHANGE DURING RETAIL TRANSACTIONS

(71) Applicant: Francis N. Hwang, Irvine, CA (US)

(72) Inventor: Francis N. Hwang, Irvine, CA (US)

(21) Appl. No.: 15/712,044

(22) Filed: Sep. 21, 2017

Related U.S. Application Data
(60) Provisional application No. 62/495,861, filed on Sep. 26, 2016.
(60) Provisional application No. 62/495,871, filed on Sep. 26, 2016.
(60) Provisional application No. 62/495,873, filed on Sep. 26, 2016.
(60) Provisional application No. 62/497,627, filed on Nov. 28, 2016.

(51) Int. Cl. G07F 7/02; G06Q 20/34; G06Q 20/20; G06Q 20/10

(52) U.S. Cl. CPC G07F 7/025; G06Q 20/10; G06Q 20/20; G06Q 20/34

(57) ABSTRACT

Systems and methods for crediting a customer account with change from cash based monetary transactions to avoid disbursing non-whole dollar change are provided. One such system includes a point of sale device configured to receive information indicative of a whole dollar cash amount received from a customer to complete a monetary transaction, read a customer account number from a customer account indicating device and generate a data set including a non-whole dollar change owed to the customer and the customer account number; and a payment processor configured to debit a bank of the retailer in an amount of the non-whole dollar change, and credit the customer account in the amount of the non-whole dollar change, and a bucket system configured to provide a software interface enabling the customer to withdraw a portion of a total of the customer account, and dispense the portion to the customer.

### CROSS-REFERENCE TO RELATED APPLICATION(S)

This application claims priority to and the benefit of (1) U.S. Provisional Application No. 62/495,861 filed on Sep. 26, 2016 and entitled, “A METHOD OF PROMOTING DIGITAL CURRENCY WORLDWIDE”, (2) U.S. Provisional Application No. 62/495,871 filed on Sep. 26, 2016 and entitled, “MECHANISMS AND PROCESSES TO ELIMINATE CHANGES IN COINS DURING A RETAIL TRANSACTION WITH CURRENCY”, (3) U.S. Provisional Application No. 62/495,873 filed on Sep. 26, 2016 and entitled, “METHODS IN CONDUCTING COINLESS RETAIL TRANSACTIONS”, and (4) U.S. Provisional Application No. 62/497,627 filed on Nov. 28, 2016 and entitled, “A SIMPLE METHOD OF IMPLEMENTING COINLESS RETAIL TRANSACTIONS”, the entire content of each is incorporated herein by reference.

### FIELD

The invention relates generally to retail transactions, and more specifically, to systems and methods for promoting digital currency by reducing the use of coin change during retail transactions.

### INTRODUCTION

Although the use of credit and debit cards in retail transactions has increased greatly during the past decade, a substantial number of retail transactions (estimated at about 35% in the U.S.), particularly in large chain stores and fast food restaurants, are still completed using paper based currencies. These cash based transactions, along with the sales tax structure of most localities, dictate that ample quantity of coins must be minted every year by governments to satisfy circulation requirements. These cash based transactions also impose burdens on all of the retailers, including regular tasks such as (1) loading and accounting the cash drawer of every point-of-sale device during every shift, and (2) forcing each cashier to count out the required change for most or all cash transactions. The cost of minting the coins, the lost value of coins stashed in every home while out of circulation, the labor hours of preparing and accounting the cash drawers, and the additional time required in counting the coins for each transaction are enormous, yet provide little economic contribution.

Therefore, any system that can reduce or eliminate non-whole dollar (or less than the lowest denomination bill) change in coins during retail transactions would contribute to savings for governments in reduction of coin production, savings of labor for the retailers in terms of reducing efforts for preparing/accounting cash drawers, and reducing/eliminating coin counting time for both the cashier and the customer. Thus, such a system could simplify and expedite cash based transactions.

Some systems and methods to eliminate or reduce change in coins during retail transactions are described in the prior art, such as U.S. Pat. Nos. 8,583,497; 7,395,958; 7,284,696; 5,869,826 and 5,650,761. These patents typically involve assigning each consumer a card that has a memory capacity (using a magnetic stripe or a memory chip) to store a unique identification number for the consumer and a balance in monetary value accumulated or reduced after a transaction. However, these approaches often suffer from the following impracticalities: (1) each retailer must equip its point-of-sales (POS) system with device that can read and write a magnetic stripe card or rewrite the memory of a smart integrated circuit (IC) chip, while virtually every POS deployed only has read-only capability; (2) the memory card described can have a balance of monetary value that can be added to or deducted from to complete a retail transaction but this typically limits the card usage to a small group of retail entities that have established credit/payment arrangements with the card issuer and are willing to compensate the issuer, which is very unlikely; (3) when writing to a memory card, it is generally required to use secure methods to verify correctness and provide tracking, thereby creating more time consuming work for retail establishments as well as for consumers to examine the accuracy in recording the coin change amounts to the memory card for each transaction; (4) such a memory card with monetary value must be protected with a password, and a lost card means either lost money for the consumer or costly replacement by the card issuer; (5) if the customer forgets to bring his memory card or the magnetic stripe on the card becomes degraded (e.g., by storing it next to a cell phone), fewer coinless transactions may be performed. All these factors contribute to the fact that the none of the approaches described in the prior art appear to have found a home in the market.

U.S. Pat. Nos. 7,395,958; 7,284,696; 5,650,761 and U.S. Patent Application No. 2007/0131760 each involve a central system that communicates with the POS of the retailers to track the memory card in use during a retail transaction in terms of verification of the identification and balance associated with the memory card. Their techniques include adjusting the balance on the memory card and instructing the POS to write to the card in use as well as making the balance available to pay for a portion of the amount, or the entire amount, of the transaction. Therefore, a memory card as described by these prior art references effectively becomes a debit card, and the entity operating the system must be liable for the payment to the retailers and must limit the card to be used for retail purchases only. The effect of these practices makes the memory card a very limited usage debit card (i.e., it cannot be used as a saving device or as a financial portal to give to charity, religious and/or political organizations), and also forces direct competition against traditional credit and debit cards which have a much wider utilization range. U.S. Pat. No. 7,284,696 has even gone one step further by suggesting setting up dispensers in many places to enable the card holder to cash out the balance, so the invention becomes nothing more than a debit card with the entity operating the system acting as a bank.

The technologies disclosed in these prior art references thus suggest two types of systems. A first system is localized at a retail store (or chain) where the non-whole dollar change (e.g., coin change) from a retail transaction stays at the local store (or chain) and the card carrier can access the coin change amount when they shop at the same store or chain. This means the customer must have a multitude of cards to perform coinless transactions in a variety of stores. The second type of system has an entity doing the central processing which receives the coin change from each transaction in a digital format and provides payment to the retailers in digital format. Using a currency along with such memory card for coin change to pay for a retail purchase greatly increase confusion between the cashier and the consumer and lengthen transaction time, particularly when there is insufficient change accumulated in the memory card so that additional paper currency must be provided to complete the purchase transaction. Thus, the benefits of going coinless are effectively lost for the retailers as well as for the consumers. Thus, better solutions for facilitating coinless cash transactions are needed.

### SUMMARY

In one aspect, the disclosure provides a system for crediting a customer account with change from cash based monetary transactions to avoid disbursing non-whole dollar change, the system comprising: a point of sale device configured to: receive, at a retailer, information indicative of a whole dollar cash amount received from a customer to complete a monetary transaction, read a customer account number from a customer account indicating device, wherein the customer account indicating device is a read-only device, and generate a data set comprising a non-whole dollar change owed to the customer and the customer account number; a payment processor configured to: debit a bank of the retailer in an amount of the non-whole dollar change, and credit a customer account corresponding to the customer account number in the amount of the non-whole dollar change; and a bucket system configured to: provide a software interface enabling the customer to withdraw a portion of a total of the customer account, and dispense the portion to the customer.

In another aspect, the disclosure provides a method for crediting a customer account with change from cash based monetary transactions to avoid disbursing non-whole dollar change, the method comprising: receiving, at a retailer, information indicative of a whole dollar cash amount received from a customer to complete a monetary transaction; reading a customer account number from a customer account indicating device, wherein the customer account indicating device is a read-only device; generating a data set comprising a non-whole dollar change owed to the customer and the customer account number; debiting a bank of the retailer in an amount of the non-whole dollar change; crediting a customer account corresponding to the customer account number in the amount of the non-whole dollar change; and providing a software interface for the customer to withdraw a portion of a total of the customer account.

In another aspect, the disclosure provides a method for conducting a monetary transaction wherein a customer is owed change at a point of sale (POS), the method comprising: receiving information indicative of a whole dollar cash amount received from the customer to complete the monetary transaction; reading a customer account number from a customer account indicating device, wherein the customer account indicating device is a read-only device; generating a data set comprising a non-whole dollar change owed to the customer and the customer account number; and sending the data set to a bucket system configured to add the non-whole dollar change to an account associated with the customer account number.

In another aspect, the disclosure provides a method for conducting a monetary transaction wherein a customer is owed change at a point of sale (POS), the method comprising: receiving information indicative of a whole dollar cash amount received from the customer to complete the monetary transaction; generating a data set comprising a non-whole dollar change owed to the customer and a customer account number; printing a receipt comprising indications of the non-whole dollar change owed to the customer and the customer account number; and sending the data set to a bucket system configured to add the non-whole dollar change to an account associated with the customer account number.

In another aspect, the disclosure provides a system for crediting a customer account with change from cash based monetary transactions to avoid disbursing non-whole dollar change, the system comprising: a bucket system configured to: receive an amount corresponding to a non-whole dollar change of a prior monetary transaction between a retailer and a customer at the retailer location; credit the amount to a customer account for the customer; provide a software interface enabling the customer to automatically withdraw a preselected portion of a total of the customer account; and dispense the preselected portion to the customer.

In another aspect, the disclosure provides a method for enabling a customer to redeem non-whole dollar change from cash based monetary transactions to avoid disbursing non-whole dollar change, the method comprising: receiving, at a retailer, information indicative of a whole dollar cash amount received from a customer to complete a monetary transaction; generating a data set comprising a non-whole dollar change owed to the customer; debiting a bank of the retailer in an amount of the non-whole dollar change; and providing a first software interface for the customer to redeem the non-whole dollar change to a customer account for the customer.

In another aspect, the disclosure provides a method for enabling a customer to redeem non-whole dollar change from cash based monetary transactions to avoid disbursing non-whole dollar change, the method comprising: receiving, at a retailer, information indicative of a whole dollar cash amount received from a customer to complete a monetary transaction; receiving, at the retailer, information indicative of an election of the customer to store a non-whole dollar change of the monetary transaction with a third party; printing, at the retailer, a receipt comprising indications of the non-whole dollar change owed to the customer and other information indicative of the monetary transaction; debiting a bank of the retailer in an amount of the non-whole dollar change; crediting a bank of the third party in an amount of the non-whole dollar change; receiving, at a location associated with the third party, the receipt; and retaining the non-whole dollar change of the receipt for the customer.

In another aspect, the disclosure provides a system for crediting a customer account with change from cash based monetary transactions to avoid disbursing non-whole dollar change, the system comprising: means for receiving, at a retailer, information indicative of a whole dollar cash amount received from a customer to complete a monetary transaction; means for reading a customer account number from a customer account indicating device, wherein the customer account indicating device is a read-only device; means for generating a data set comprising a non-whole dollar change owed to the customer and the customer account number; means for debiting a bank of the retailer in an amount of the non-whole dollar change; means for crediting the customer account in the amount of the non-whole dollar change; and means for enabling the customer to withdraw a portion of a total of the customer account.

### BRIEF DESCRIPTION OF THE DRAWINGS

FIG. 1 is a transaction flow diagram illustrating interaction between a customer and a transaction system for crediting a customer account with non-whole dollar change from a cash based monetary transaction in accordance with one embodiment of the disclosure.

FIG. 2 is a flow chart illustrating an overall process for crediting a customer account with non-whole dollar change from cash based monetary transactions in accordance with one embodiment of the disclosure.

FIG. 3 is a flow chart illustrating a process for crediting a customer account with non-whole dollar change from cash based monetary transactions at a point of sale device in accordance with one embodiment of the disclosure.

FIG. 4 is a flow chart illustrating a process for crediting a customer account with non-whole dollar change from cash based monetary transactions at a bucket system in accordance with one embodiment of the disclosure.

FIG. 5 is a block diagram illustrating a transaction system for crediting a customer account with non-whole dollar change from cash based monetary transactions in accordance with one embodiment of the disclosure.

FIGS. 6 and 7 illustrate a flow chart showing an overall detailed process for crediting a customer account with non-whole dollar change from cash based monetary transactions in accordance with one embodiment of the disclosure.

FIG. 8 is a perspective diagram of a point of sale device at a retailer in accordance with one embodiment of the disclosure.

FIG. 9 is a perspective diagram of a point of sale device at a restaurant in accordance with one embodiment of the disclosure.

FIG. 10 is a top view of various assigned customer account indicating devices in accordance with one embodiment of the disclosure.

FIG. 11 is a top view of an unassigned customer account indicating device in accordance with one embodiment of the disclosure.

FIG. 12 illustrates various views of customer account indicating devices involving RFID technology in accordance with one embodiment of the disclosure.

FIG. 13 is a top view of a customer printed receipt illustrating a customer account number and a non-whole dollar change owed to the customer for a monetary transaction in accordance with one embodiment of the disclosure.

FIG. 14 is a perspective view of components that can be used by a customer to register a new account for collecting non-whole dollar change in accordance with one embodiment of the disclosure.

FIG. 15 is a perspective view of components that can be used by a customer to modify an account for collecting non-whole dollar change in accordance with one embodiment of the disclosure.

FIG. 16 is a perspective view of components that can be used by a customer to dispense funds stored in an account for collecting non-whole dollar change in accordance with one embodiment of the disclosure.

FIG. 17 is a top view of a notification to a customer that funds stored in his account for collecting non-whole dollar change will be disbursed in accordance with one embodiment of the disclosure.

FIG. 18 is a flow chart illustrating a process for crediting a customer account with non-whole dollar change from cash based monetary transactions at a point of sale device including printing a receipt in accordance with one embodiment of the disclosure.

FIG. 19 is a flow chart illustrating a process for crediting a customer account with non-whole dollar change from cash based monetary transactions in accordance with one embodiment of the disclosure.

FIG. 20 is a flow chart illustrating a process for enabling a customer to redeem non-whole dollar change from cash based monetary transactions from a third party in accordance with one embodiment of the disclosure.

### DETAILED DESCRIPTION

Referring now to the drawings, embodiments of systems and methods for crediting a customer account with non-whole dollar change from cash based monetary transactions are illustrated. One such system includes a point of sale device, a payment processor, and a bucket system. In such case, the point of sale device can be configured to receive, at a retailer, information indicative of a whole dollar cash amount received from a customer to complete a monetary transaction, read a customer account number from a customer account indicating device, where the customer account indicating device is a read-only device, and generate a data set including a non-whole dollar change owed to the customer and the customer account number. The payment processor can be configured to debit a bank of the retailer in an amount of the non-whole dollar change, and credit a customer account corresponding to the customer account number in the amount of the non-whole dollar change. The bucket system bank can be configured to provide a software interface enabling the customer to withdraw a portion of a total of the customer account, and dispense the portion to the customer. Additional methods and sub-systems may be used as well.

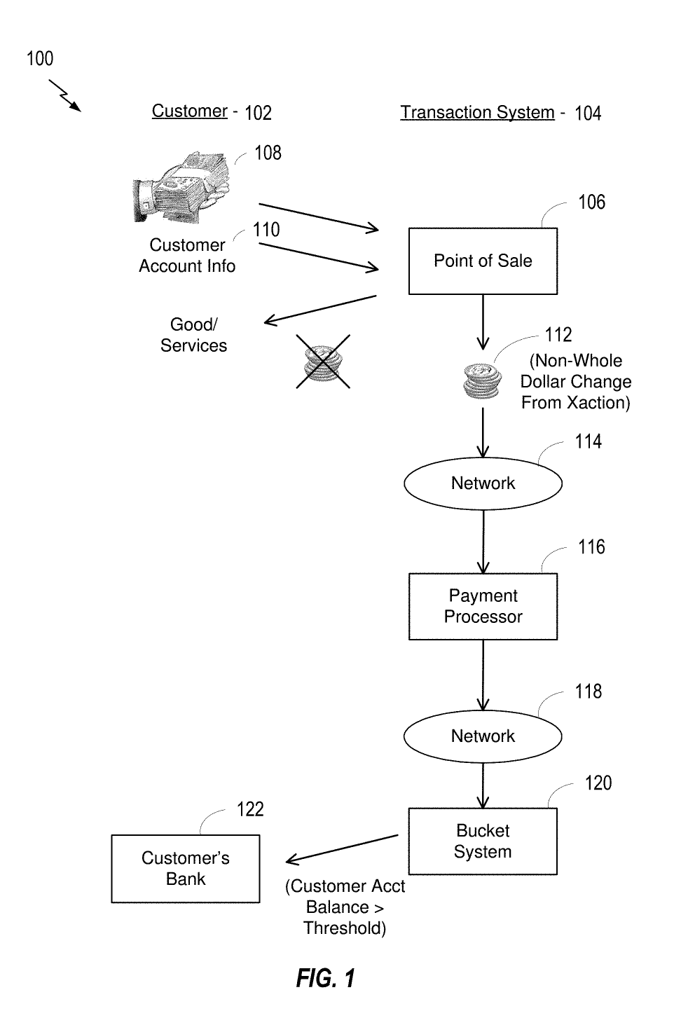

FIG. 1 is a transaction flow diagram 100 illustrating interaction between a customer 102 and a transaction system 104 for crediting a customer account with non-whole dollar change from a cash based monetary transaction in accordance with one embodiment of the disclosure. At a retailer, the customer 102 may purchase goods and/or services using any number of payment methods. As discussed above, for cash based transactions, many retailers and some customers may wish to avoid the hassles associated with use of coin based cash (e.g., non-whole dollar cash). As used herein, the term “dollar” is defined to include dollar based currencies of the United States of America and paper based currencies of other countries.

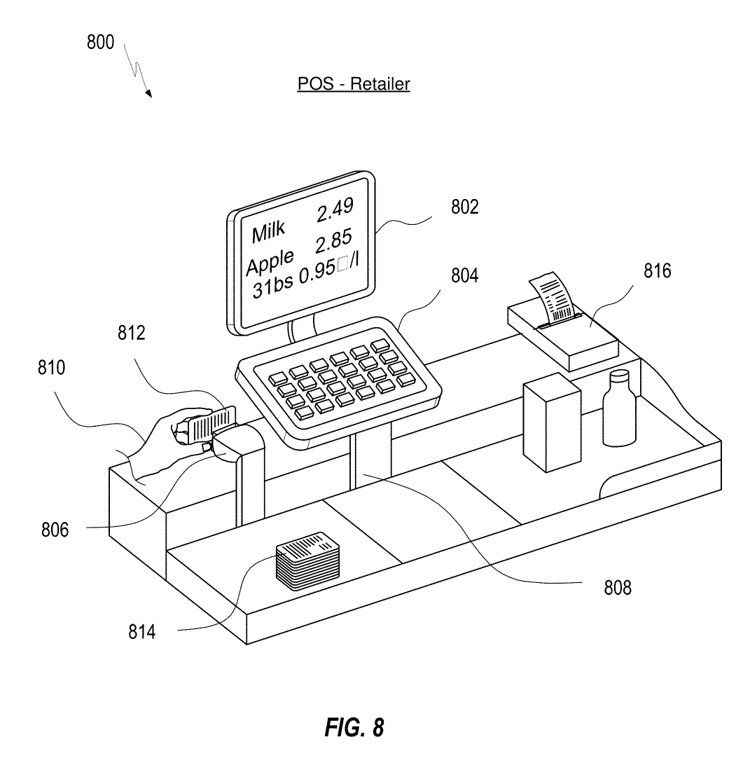

In one example, the customer 102 approaches a cashier stationed at a point of sale device (POS) 106 (at the retailer) to purchase a good or service (e.g., execute a monetary transaction). The cashier may scan or manually enter the information associated with the desired good or service in to the POS 106. The customer 102 may provide cash 108 to pay for the good or service. In which case, the cashier may prompt the customer 102 to use a deposit account for collecting non-whole dollar change (e.g., bucket account) to complete the transaction. He/she may offer the customer 102 a new account card (e.g., unassigned card) if the customer does not already have an account. The customer 102 may also offer his customer account information if he/she already has an account without being prompted. In several examples, the customer 102 provides a customer account indicating device (not shown in FIG. 1 but see 812 in FIG. 8) which can be read by a device (e.g., card reader, scanner, RFID scanner, and the like) attached to the POS 106. In several embodiments, the customer account indicating device is a read-only device. In one aspect, the read-only device is a device from which information may be read but information may not be written to it.

Once the customer account indicating device is read, the POS 106 can generate a data set including the customer account number 110 and the amount of the non-whole dollar change 112 owed to the customer 102 for the current transaction. The POS 106 can send the data set over a network 114 to a payment processor 116 or another suitable entity for settling payments between banks. Network 114 may be a public network such as the Internet, an intranet, a private network, or any other suitable network for exchanging information between computing devices.

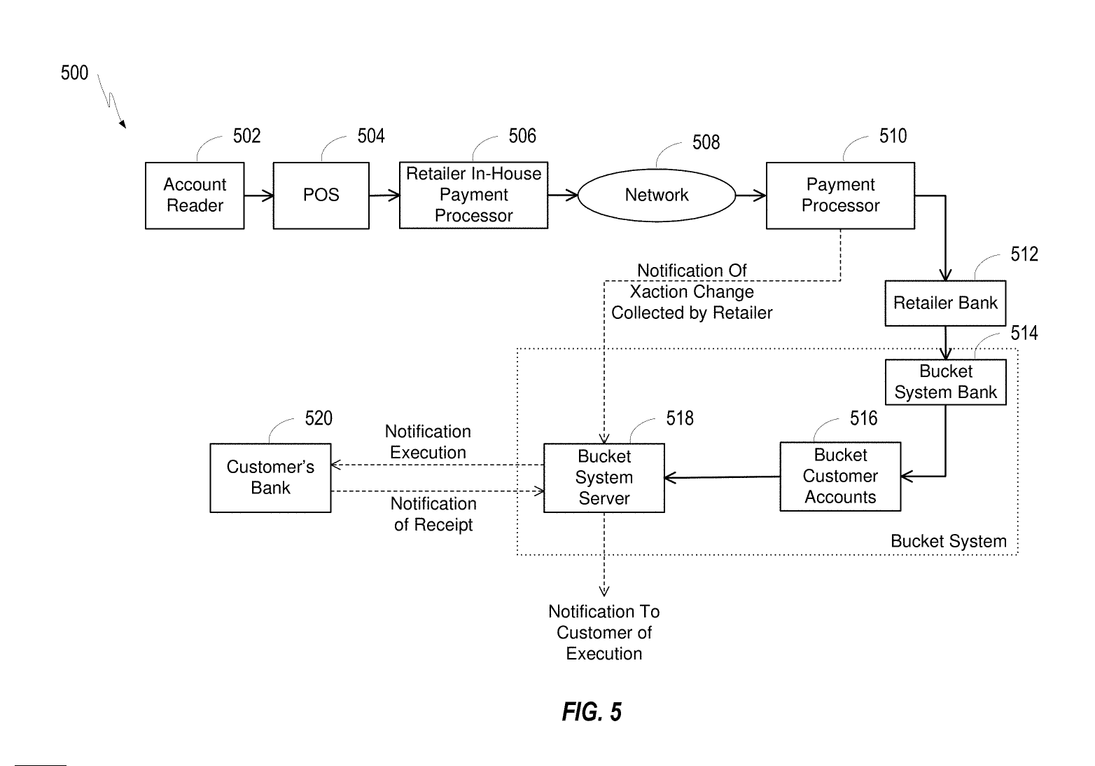

The payment processor 116 can debit a bank for the retailer (not shown but see 512 in FIG. 5) in the amount of the non-whole dollar change 112 owed to the customer 102. The payment processor 116 can also credit a customer account (e.g., account for customer 102) at a bank (e.g., bucket system bank) within a bucket system 120. The “bucket system bank” as used herein can refer to a bank for the bucket system 120. In one aspect, it is a third party bank used by the bucket system to store funds for bucket system customers and/or the bucket system itself. In another aspect, the “bucket system bank” may be a bank operated by the bucket system rather than a third party bank. The payment processor 116 may be coupled to the bucket system 120 via network 118. Network 118 may be a public network such as the Internet, an intranet, a private network, or any other suitable network for exchanging information between computing devices. The payment processor 116 may be a payment processor as is known in the art for the settlement of payments between banks.

Bucket system 120 may be formed of multiple components (e.g., including the bucket system bank storing funds for the customer) and provides a software interface for the customer 102 to withdraw a portion of the total stored in his/her account. In one example, the customer 102 or policy administrator of the bucket system 120 may set a preselected minimum threshold amount (e.g., $50) for a withdrawal. In one aspect, the customer 102 can make the withdrawal automatic such that the bucket system automatically deposits the preselected amount into a customer's bank 122 once the threshold amount has been accumulated. Further aspects of the bucket system 120 will be described below.

As to the customer account indicating device, it may be a device with a bar code, a device with a magnetic stripe, a device with a quick response (QR) code, a device with an RFID, a device with an integrated circuit, and/or combinations thereof.

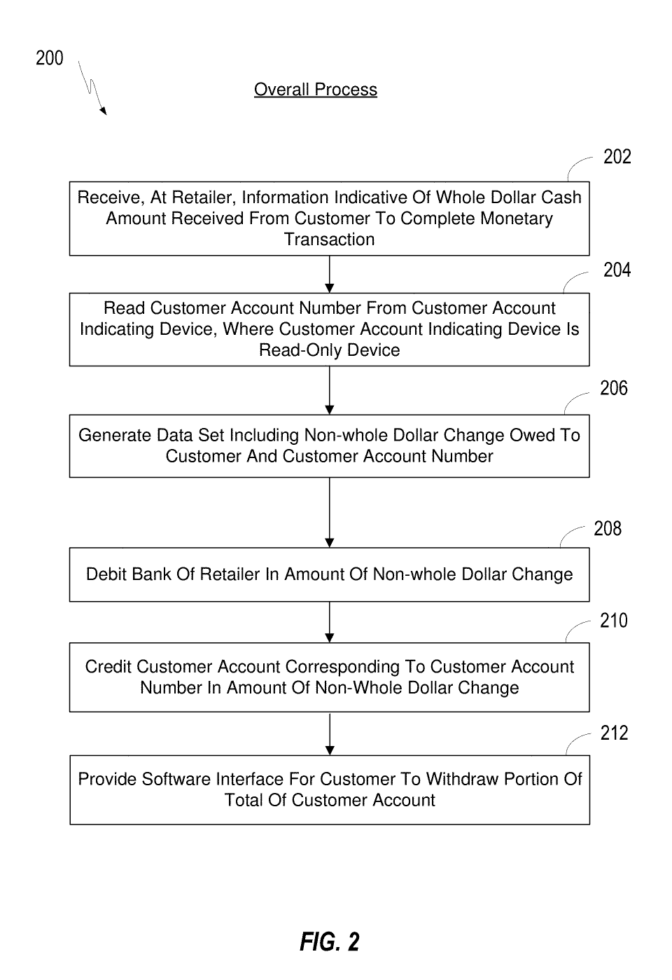

FIG. 2 is a flow chart illustrating an overall process 200 for crediting a customer account with non-whole dollar change from cash based monetary transactions in accordance with one embodiment of the disclosure. In one aspect, the process 200 can be performed by components of the transaction system 104, including, for example, the POS 106, the payment processor 116, and/or the bucket system 120 of FIG. 1. At block 202, the process receives, at a retailer, information indicative of a whole dollar cash amount received from a customer to complete a monetary transaction. In one aspect, the amount received is greater than the amount due. In one aspect, the information is received by a point of sale device. At block 204, the process reads a customer account number from a customer account indicating device, where the customer account indicating device is a read-only device. In one aspect, the customer account indicating device may be a device with a bar code, a device with a magnetic stripe, a device with a QR code, a device with an RFID, a device with an integrated circuit, and/or combinations thereof. In one aspect, the device may be a mobile phone with a screen configured to show a barcode or a QR code. In several embodiments, the customer account number is an account number assigned to the customer at a bucket system bank (not visible in FIG. 2 but see 120 in FIGS. 1 and 514 in FIG. 5).

At block 206, the process generates a data set including a non-whole dollar change owed to the customer (for the monetary transaction) and the customer account number. In one aspect, this data set (e.g., transaction data package) can further include information such as (1) transaction amount, (2) sales tax amount, (3) credit/debit authorization number, if used, (4) amount of non-whole dollar change owed customer, (5) customer's account number, (6) store identification number, (7) time/date, and/or (8) other information related to the transaction. In one aspect, the data package may be sent to an in-house transaction tracking/inventory management/accounting system which can, in turn, send the data package to the outside payment processor. In one aspect, the actions of blocks 202, 204, and 206 may be performed by a POS device or a device attached thereto. In one aspect, the POS device (e.g., such as POS 106 of FIG. 1 or POS 504 of FIG. 5) may be a means for performing any of the actions of blocks 202, 204, and 206.

At block 208, the process debits a bank of the retailer in an amount of the non-whole dollar change. In one aspect, the process first extracts the information indicative of the amount of the non-whole dollar change from the data set generated in block 206, and then debits the bank of the retailer for the amount. At block 210, the process credits a customer account corresponding to the customer account number (at a bucket system bank) in the amount of the non-whole dollar change. In one aspect, the actions of blocks 208 and 210 can be performed by a payment processor such as payment processor 116 of FIG. 1. In one aspect, the actions of blocks 208 and 210 can be performed on a per transaction base, on an aggregated base, and/or on periodic base. In one aspect, the payment processor (e.g., such as payment processor 116 of FIG. 1 or payment processor 506 or 510 of FIG. 5) may be a means for performing any of the actions of blocks 208 and 210.

At block 212, the process provides a software interface for the customer to withdraw a portion of a total of the customer account. In one aspect, the software interface enables the customer to (1) view a total funds in the account, (2) set a threshold for making an automatic withdrawal, (3) view information about the dispensing of funds, (4) register a new account, and/or (5) reconcile a new/temporary account with an existing account (e.g., when the customer visits a retailer but does not have his/her account information with him/her and has his/her non-whole dollar change instead credited to a temporary account). In one aspect, the software interface may be available to the customer by way of (1) an application program configured to run on a mobile telephone or tablet computer and/or (2) a web interface program that can be accessed, via the Internet, from any sort of computer (e.g., a laptop, a desktop, mobile telephone or any other computing device configured to access the Internet). In one aspect, the process also adds the amount of the non-whole dollar change to a prior total of the customer account. In one aspect, the actions of block 212 can be performed by the bucket system 120 of FIG. 1. In one aspect, the bucket system (e.g., such as bucket system 120 of FIG. 1 or bucket system 514, 516, 518 of FIG. 5) may be a means for performing any of the actions of block 212. More specifically, in one such case, bucket system server 518 may be a means for performing the actions of block 212.

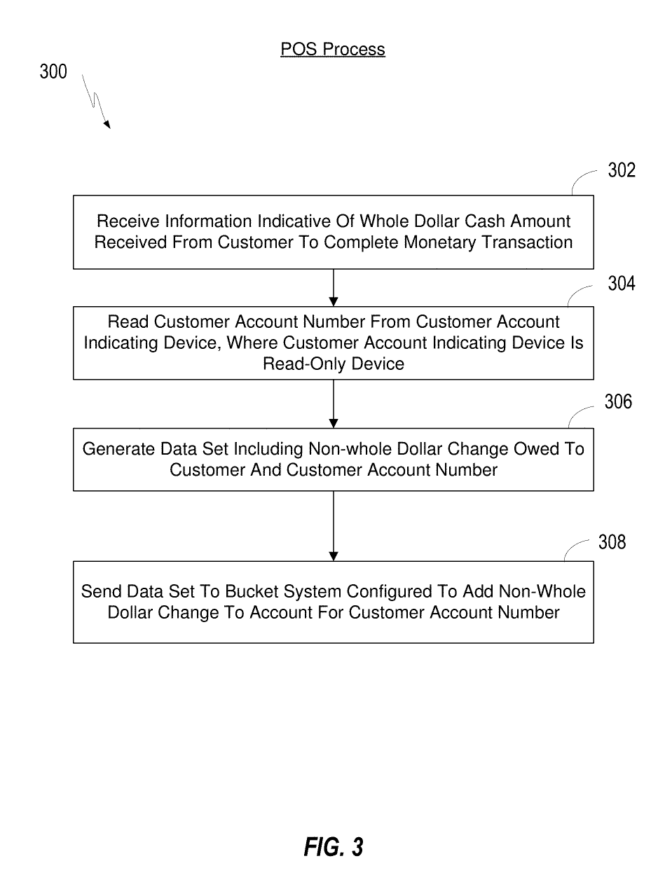

FIG. 3 is a flow chart illustrating a process 300 for crediting a customer account with non-whole dollar change from cash based monetary transactions at a point of sale device in accordance with one embodiment of the disclosure. In one aspect, the process may be performed by the point of sale (POS) device 106 of FIG. 1. At block 302, the process receives information indicative of a whole dollar cash amount received from the customer to complete the monetary transaction. In one aspect, this information may have been entered by a cashier who received the whole dollar cash amount from the customer. At block 304, the process reads a customer account number from a customer account indicating device, where the customer account indicating device is a read-only device. At block 306, the process generates a data set including a non-whole dollar change owed to the customer and the customer account number. At block 308, the process sends the data set to a bucket system configured to add the non-whole dollar change to an account associated with the customer account number.

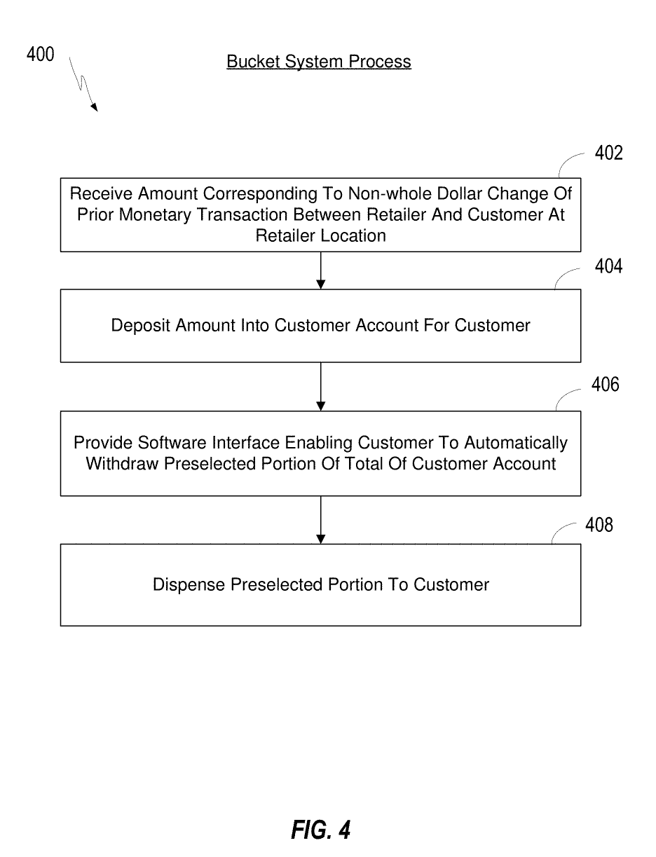

FIG. 4 is a flow chart illustrating a process 400 for crediting a customer account with non-whole dollar change from cash based monetary transactions at a bucket system in accordance with one embodiment of the disclosure. In one aspect, the process 400 may be performed by the bucket system 120 of FIG. 1 or bucket system of FIG. 5. At block 402, the process receives an amount corresponding to a non-whole dollar change of a prior monetary transaction between a retailer and a customer at the retailer location. In one aspect, the amount received is the non-whole dollar change of the prior monetary transaction owed to the customer. At block 404, the process deposits the amount into a customer account for the customer. In one aspect, the deposit may be a digital credit of the customer account. At block 406, the process provides a software interface enabling the customer to automatically withdraw a preselected portion of a total of the customer account. In one aspect, the preselected portion is determined by the operator of the bucket system or by the customer. At block 408, the process dispenses the preselected portion to the customer. In one aspect, the process receives a confirmation from the customer's bank of a successful deposit of the preselected portion to the customer's bank account. In one aspect, the process notifies the customer about the successful dispensing of the customers funds from the bucket system bank.

FIG. 5 is a block diagram illustrating a transaction system 500 for crediting a customer account with non-whole dollar change from cash based monetary transactions in accordance with one embodiment of the disclosure. In describing the transaction system 500, it is useful to consider the illustrated path of actions. After a customer desiring to purchase a good/service has tendered cash in the form of whole-dollars (e.g., to a cashier who enters the amount tendered into POS 504) and indicated a desire to use a deposit account for the non-whole dollar change, an account reader 502 may read a customer account number from a customer account indicating device of the customer. The customer account indicating device may be a read-only card storing an account number of the customer seeking to complete the financial transaction. The account reader 502 is coupled to a point of sale device (POS) 504. In one aspect, the cashier may have received a cash amount from the customer in paper currency in excess of the amount due.

The POS 504 can determine the amount of change due to the customer and generate a data set including a non-whole dollar change owed to the customer and the customer account number. The POS 504 can send the data set to a retailer in-house payment processing 506 which may store the data set and send it, via network 508, to an outside payment processor 510. In one aspect, the in-house payment processing 506 can conduct tasks such as transaction tracking, inventory adjustment/ordering, and/or accounting functions, besides forwarding the data set to an outside payment processor 510. In one aspect, the system does not include the retailer in-house payment processing 506 and the POS 504 sends the data set directly to the payment processor 510.

The payment processor 510 can notify the retailer bank 512 to transfer money from the retailer bank 512 to the bucket system bank 514 in the amount of the non-whole dollar change owed to the customer. In effect, the payment processor 510 debits the retailer bank 512 and credits the customer account 516 at the bucket system bank 514 for the amount of the non-whole dollar change owed to the customer. The payment processor 510 can also send a notification of the transaction change collected by the retailer to a bucket system server 518. The bucket system server 518 can a provide software interface enabling the customer to withdraw a preselected portion of a total of their bucket customer account. In one example, the bucket system server 518 stores a preselected threshold (e.g., preselected portion) for the bucket customer account. Once the account total exceeds the preselected threshold, an amount equal to the preselected threshold (e.g., preselected portion) is transferred to a customer's bank 520. In one aspect, the customer's bank 520 may be replaced by another vessel for dispensing the funds. In one such case, the alternative vessel can be a gift card or a charity organization.

The bucket system bank 514, the bucket customer accounts 516, and bucket server system 518 can be collectively referred to as a bucket system, like the bucket system 120 of FIG. 1. In making the transfer of funds from the bucket system (e.g., from the bucket system bank 514) to the customer's bank 520, the bucket system server 518 can send a notice of execution of the transfer of funds. In response, the customer's bank 520 can send a notification of receipt of the funds to the bucket system server 518. Once the funds are transferred, the bucket system server 518 can send a notification to the customer providing the salient details related to the dispensing of funds.

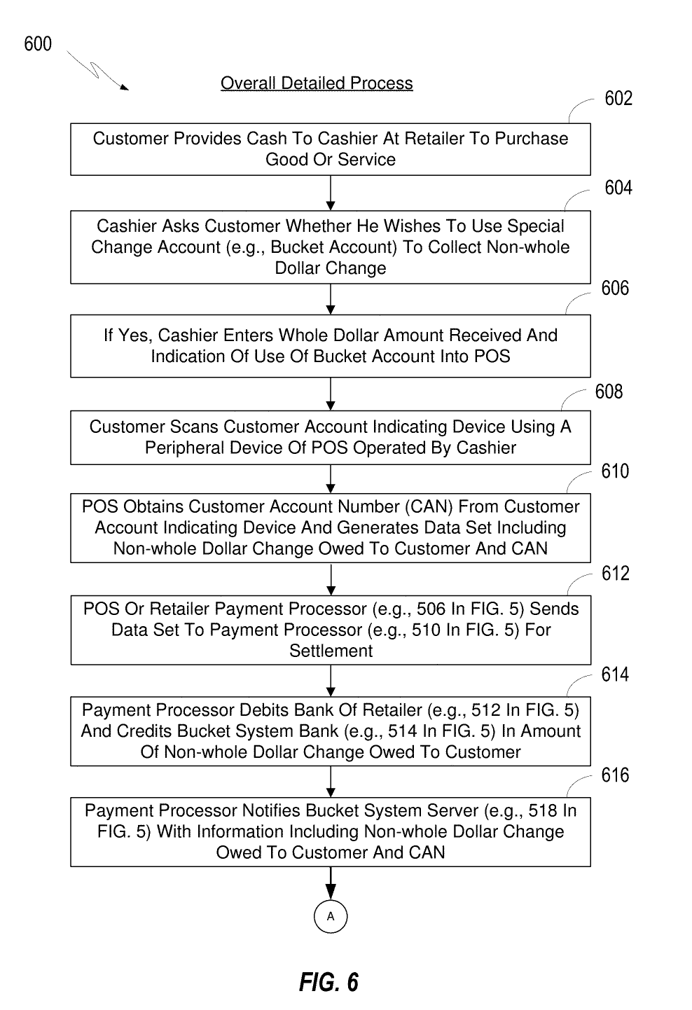

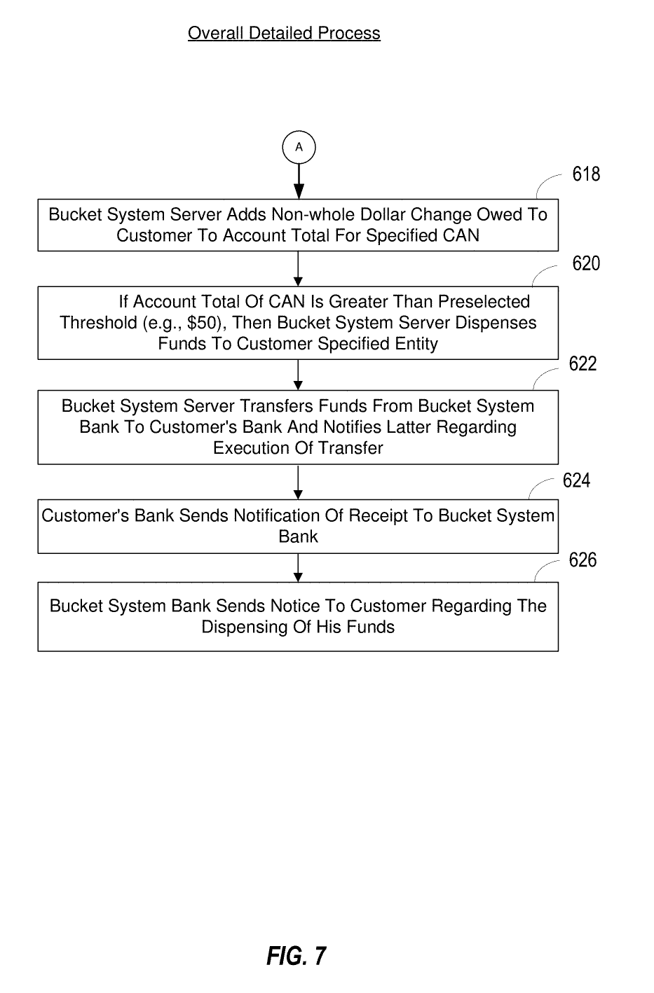

FIGS. 6 and 7 illustrate a flow chart showing an overall detailed process 600 for crediting a customer account with non-whole dollar change from cash based monetary transactions in accordance with one embodiment of the disclosure. In one aspect, the process 600 can be performed by the transaction system 500 of FIG. 5, or the transaction system 104 of FIG. 1. At block 602, the customer provides cash to cashier at retailer to purchase a good or service. At block 604, the cashier asks the customer whether he/she wishes to use a special change account (e.g., bucket account) to collect the non-whole dollar change from the pending transaction. At block 606, and if the customer says yes, the cashier enters whole dollar amount received and makes an indication of the use of a bucket account into the POS (e.g., 504 in FIG. 5). If the customer says no (action not shown), then the cashier and general process can proceed with a conventional cash based transaction.

At block 608, the customer (or cashier) scans/presents his customer account indicating device using a peripheral device (e.g., account reader 502 in FIG. 5 such as card reader, RFID reader, barcode reader, etc.) of the POS operated by the cashier. In one aspect, the customer may use an unassigned customer account indicating device available at the POS if the customer somehow does not have a way of providing his account number (e.g., forgot his customer account indicating device or forgot the account number). In one aspect, the cashier or POS may obtain a linkage information from the customer. The linkage information may include a password, a customer birthday, a customer telephone, a symbol, another unique number, or any combination of these. The linkage information can be used to associate the non-whole dollar change with a customer account number, and will be discussed in greater detail below.

At block 610, the POS obtains the customer account number from the customer account indicating device and generates a data set including a non-whole dollar change owed to the customer and the customer account number.

At block 612, the POS and/or the retailer in-house payment processor (e.g., 506 in FIG. 5) sends the data set to an external payment processor (e.g., 510 in FIG. 5) for settlement. In one aspect, the POS data can be queried at a fixed interval by an accounting process running on the retailer in-house payment processor to reconcile the cash drawer as well as credit the change collected by this POS to the entity that conducts this coinless transaction process (e.g., bucket system).

At block 614, the payment processor debits a bank of the retailer (e.g., 512 in FIG. 5) and credits a bucket system bank (e.g., 514 in FIG. 5) in an amount equal to the non-whole dollar change owed to the customer.

At block 616, the payment processor also sends a notification to a bucket system server (e.g., 518 in FIG. 5) containing information including the non-whole dollar change owed to the customer and the customer account number.

At block 618, the bucket system server adds the non-whole dollar change owed to the customer to the account total for the specified customer account number.

At block 620, and if the account total of the customer account number is greater than a preselected threshold (e.g., $50), then the bucket system server dispenses funds to a customer specified entity (e.g., customer's bank 520 in FIG. 5). At block 622, and assuming the condition to be true, the bucket system server transfers the funds from the bucket system bank to the customer's bank and notifies the latter regarding the execution of the transfer. At block 624, the customer's bank can send a notification of receipt to the bucket system bank. At block 626, the bucket system bank can send a notice to the customer regarding the dispensing of his funds. If the account total of the customer account number is not greater than the preselected threshold, then the bucket system server can keep accumulating funds in the customer account and not perform the actions of blocks 622 to 626.

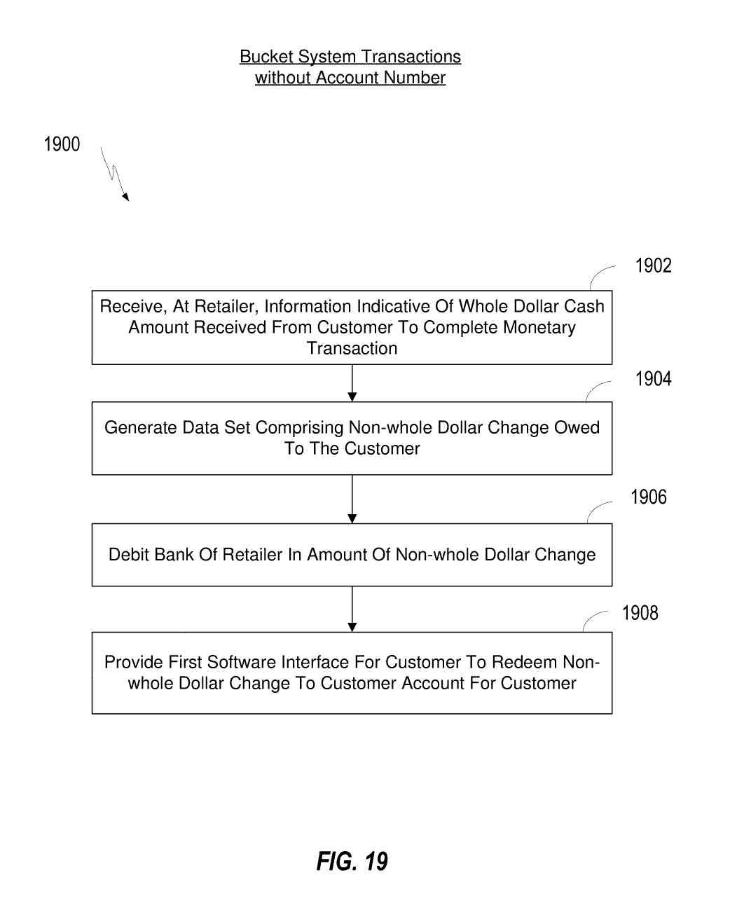

In one aspect, the customer may not have established a saving account for the non-whole dollar change or simply does not remember account number or any linkage information for linking to his account but still wants to store his non-whole dollar changes. In such case, the cashier at a retailer location can simply execute the coinless transaction without the input of a customer account number or a linkage number set. The POS 504 (e.g., through an integrated device) can print a receipt specifying the amount of non-whole dollar change saved along with the transaction details, store identification and time/date. The POS 504 or the in-house processing center 506 can send the transaction data set with the non-whole dollar change to the outside payment processing center 510, which in turn can debit the retailer bank 512 for the non-whole dollar change amount and credit the bucket system bank 514. The bucket server 518 can then assign this amount to a house account (e.g., bucket system house account) for reconciliation at a later time. When the customer visits a website hosting a software interface to the non-whole dollar change saving account, he/she can then establish an account 516 and input the receipt (e.g. via smart phone barcode or QR code scanning function), or details of the receipt, for reconciliation. The bucket server 518 can then allocate the amount input via the receipt into the customer's account 516. Aspects of this embodiment as described in further detail below in conjunction with FIG. 19.

FIG. 8 is a perspective diagram of a point of sale device 800 at a retailer in accordance with one embodiment of the disclosure. The point of sale device 800 includes a display 802, a keyboard 804 for entering information, and a card reader 806. The point of sale device 800 may also include a bar code scanner 808. In operation, a customer 810 can present a customer account indicating device 812 (shown as a card with a bar code here) to the card reader 806 when prompted by the POS device 800 or cashier (not shown). The customer account indicating device 812 may be a device previously assigned to the customer. Alternatively, the customer account indicating device 812 may be a device not previously assigned to the customer 810 and just acquired from a stack of unassigned customer account indicating devices 814.

As to the card reader 806, it may be replaced by another peripheral device for receiving a customer account number from the customer via the customer account indicating device 812. Example peripheral devices include a card reader, a bar code scanner, a RFID scanner, and the like.

As to the POS device 800, it may include a processor coupled to a memory and a communications interface for sending a data set. The memory may include both volatile and non-volatile memory. The processor may be configured to execute programming instructions stored in the memory for executing any of the actions described herein that are performed by the POS device. In one embodiment, the processor, memory and communications interface can be implemented in the keyboard 804 (e.g., keyboard/central processing unit (CPU)).

In this context, the processor contained within POS 800 may refer to any machine or selection of logic that is capable of executing a sequence of instructions and should be taken to include, but not limited to, general purpose microprocessors, special purpose microprocessors, central processing units (CPUs), digital signal processors (DSPs), application specific integrated circuits (ASICs), signal processors, microcontrollers, and other suitable circuitry. Further, it should be appreciated that the term processor, microprocessor, circuitry, controller, and other such terms, refer to any type of logic or circuitry capable of executing logic, commands, instructions, software, firmware, functionality, or other such information.

In one aspect, the keyboard 804 in POS device 800 can also include a set of special function keys that can activate the CPU to perform a set of functional steps associated with the methods disclosed herein (e.g., such as to perform a coinless retail transaction, a specific discount on a specific item or any promotional activity).

In one aspect, POS device 800 can be a typical point of sale device located at a retailer. The POS device 800 can also include a printer 816 configured to print receipts.

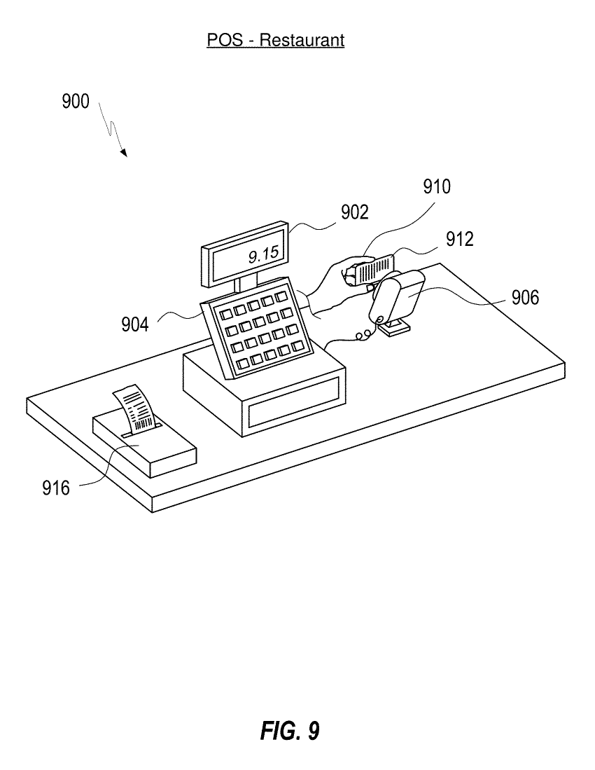

FIG. 9 is a perspective diagram of a point of sale device 900 at a restaurant in accordance with one embodiment of the disclosure. The point of sale device 900 includes a display 902, a keyboard 904 for entering information (which may include special function keys as described above), and a card reader 906. In operation, a customer 910 can present a customer account indicating device 912 (shown as a card with a bar code here) to the card reader 906 when prompted by the POS device 900 or cashier (not shown). The POS device 900 can also include a printer 916 configured to print receipts. In one aspect, the POS device 900 may include the same or similar sub-components (e.g., processor, memory, communications interface, etc.) as are discussed above for the POS 800 of FIG. 8.

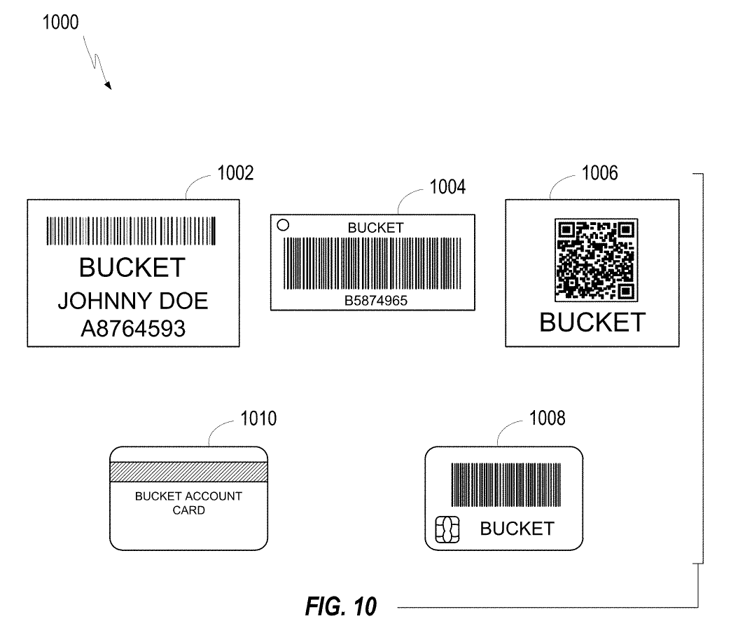

FIG. 10 is a top view of various assigned customer account indicating devices 1000 in accordance with one embodiment of the disclosure. The customer account indicating devices 1000 include a first device 1002 having a form factor of a typical credit card size plastic or durable paper device (e.g., 2⅛ inches wide by 4⅜ inches long by 1/32 inches thick) having a barcode, a customer account number, and the customer's name imprinted on one side. The devices 1000 further include a second device 1004 having a form factor of a typical keychain sized card (e.g., 1 inch wide by 1⅞ inch long by 1/64 inch thick) with a barcode and a customer account number imprinted on one side.

The devices 1000 further include a third device 1006 having a form factor of a keychain card (similar to device 1004) imprinted with two-dimensional barcode (or QR code) on one side. The devices 1000 further include a fourth device 1008 having a form factor of a credit card and can include a RFID circuitry (a passive radio frequency identification chip along with, or without, a barcode to identify the customer account number). The devices 1000 further include a fifth device 1010 having a form factor of a typical credit card size with a magnetic stripe to store the customer account number. Each of the customer account indicating devices 1000 depicted in FIG. 10 are configured to store a customer account number for a bucket system bank. In one aspect, each of the devices 1000 can be read-only devices.

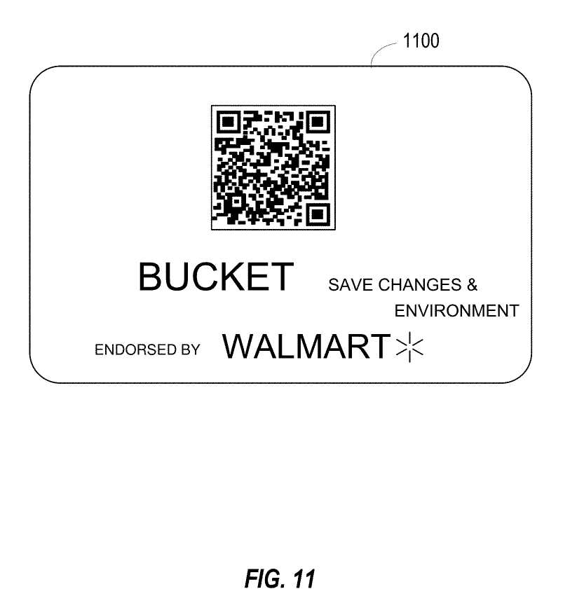

FIG. 11 is a top view of an unassigned customer account indicating device 1100 in accordance with one embodiment of the disclosure. The customer account indicating device 1100 is a card imprinted with two-dimensional barcode (or QR code) on one side. While the card 1100 is designated for a WALMART customer, it can be used for any retailer and can include their specific store name imprinted thereon. In one aspect, the unassigned customer account indicating device 1100 can be used if/when the customer did not have such a device to begin with, or did not bring his/her device (e.g., forgot it) to complete the financial transaction.

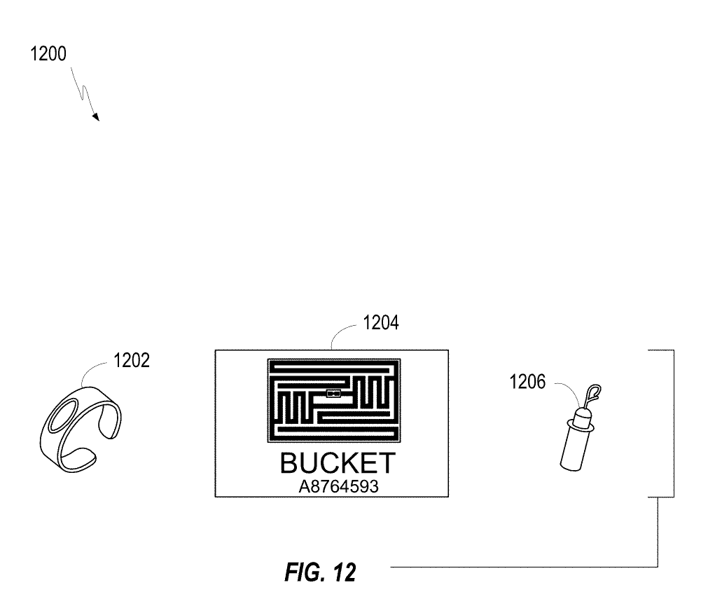

FIG. 12 illustrates various views of customer account indicating devices 1200 involving RFID technology in accordance with one embodiment of the disclosure. The devices 1200 include (1) a first device 1202 having a form factor of a keychain wan, a second device 1204 having a form factor of a keychain card, and a third device 1206 having a form factor of a keychain decorative tag.

In other embodiments, the customer account indicating devices 1200 involving RFID technology can have a form factor including a ring type jewelry or other jewelry, or another suitable form factor.

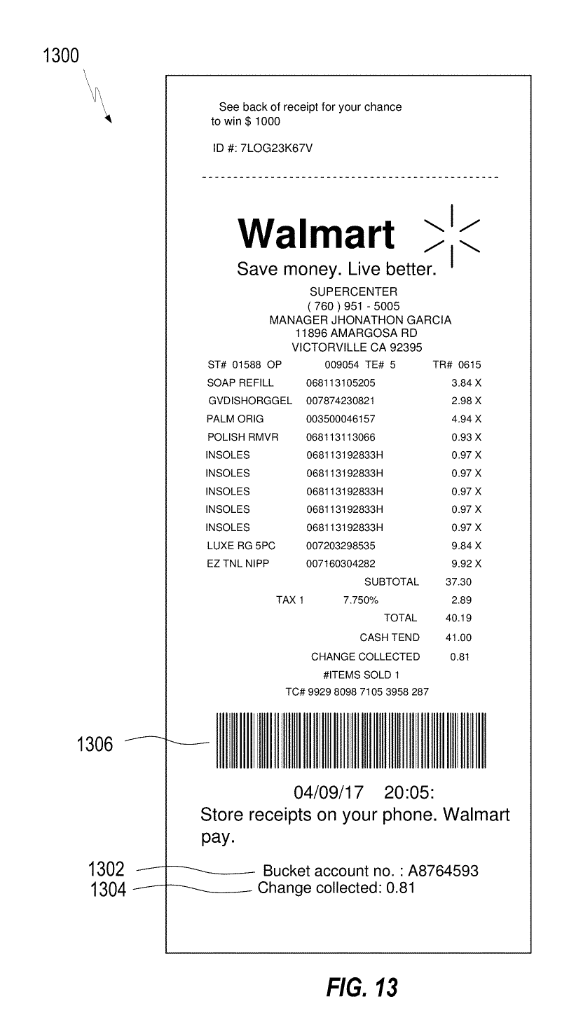

FIG. 13 is a top view of a customer printed receipt 1300 illustrating a customer account number 1302 and a non-whole dollar change owed to the customer 1304 for a monetary transaction in accordance with one embodiment of the disclosure. The customer receipt 1300 depicts a Wal-Mart receipt as an example, and demonstrates how a transaction receipt can have a bar code 1306 (or QR code) added to indicate the non-whole dollar change being saved along with the store number and time. A customer without a customer account number for the bucket system at this purchase, or one who forgets to bring his/her bucket account card, can use the printed receipt 1300 to add his/her saved non-whole dollar change from the transaction into a customer bucket account later by going to the bucket website to do the reconciliation.

While the mark WALMART is shown in FIGS. 11 and 13, this disclosure and the related inventions are not affiliated with, endorsed by, or in any way associated with WALMART. WALMART and/or “Save money. Live better.” are registered trademarks of Wal-Mart Stores, Incorporated of Bentonville, Ark.

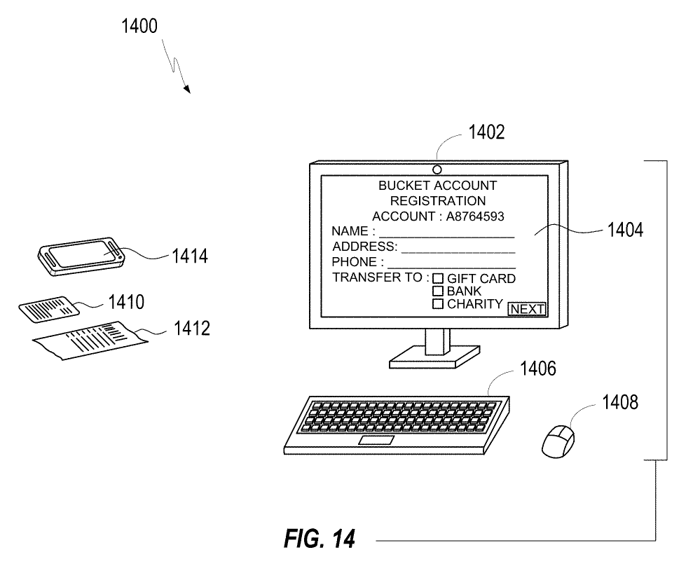

FIG. 14 is a perspective view of components 1400 that can be used by a customer to register a new account for collecting non-whole dollar change in accordance with one embodiment of the disclosure. The components 1400 include a monitor 1402 displaying a customer account registration screen 1404 for a bucket system bank (e.g., bucket account registration screen). This registration screen may be available at a website for the bucket system. The registration information includes name, address, and phone fields, along with check boxes to designate a disbursement target entity. The disbursement target entities include a gift card, a bank, and a charity. The components 1400 further include a keyboard 1406 and mouse 1408 for entering information associated with identifying the customer and customer preferences. In other embodiments, additional input devices can be coupled to the monitor 1402 which can include a central processing unit.

The components 1400 can also include a customer account indicating device 1410 that may be scanned to identify the customer account number. The components 1400 can also include a printed receipt 1412 that may be scanned to identify the customer account number and or other relevant information from the transaction (e.g., the non-whole dollar change amount). The components 1400 can also include a mobile telephone 1414 that may communicate transaction information to the computer/display 1402 to facilitate the customer registration. Alternatively, mobile telephone 1414 may be used communicate transaction information directly to the bucket system server/website to facilitate the customer registration. Alternatively, mobile telephone 1414 can be used to scan the printed receipt 1412 and communicate with the bucket system 120 in FIG. 1 for reconciliation.

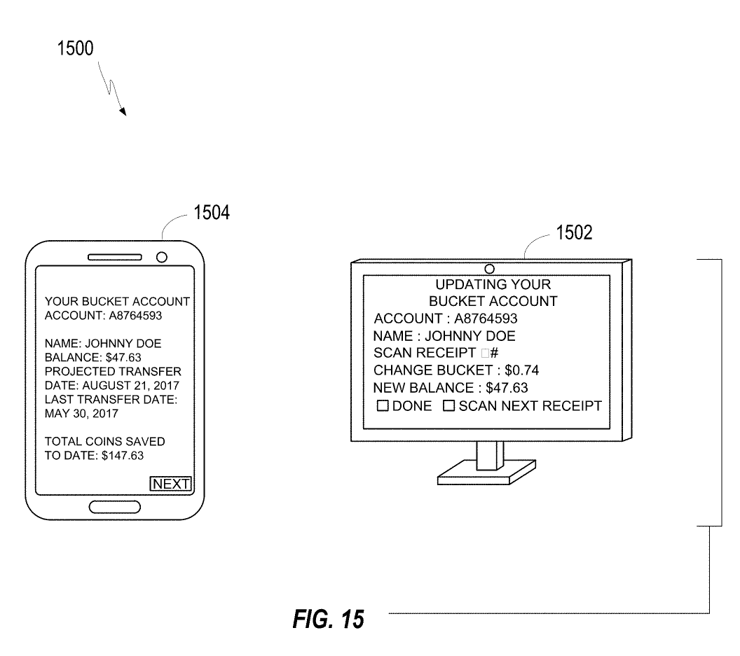

FIG. 15 is a perspective view of components 1500 that can be used by a customer to modify an account for collecting non-whole dollar change in accordance with one embodiment of the disclosure. The components include a monitor/computer 1502 configured to access a website (provided, for example, by a bucket system server website) at which the customer may update information related to his customer account at the bucket system bank (e.g., bucket account). The components further include a mobile telephone 1504 also configured to access the website. In one aspect, the mobile telephone 1504 may be replaced by a tablet computer, a handheld computer, or any other computing device configured to access a website. In one aspect, the mobile telephone 1504 may include special programming (e.g., an application executing on the telephone) that enables it to access the website using the special programming.

In one aspect, the customer may use the website to verify his/her bucket account status and/or reconcile the balance by combining amounts accumulated in other bucket accounts for transactions where the customer forgot to bring his bucket card and used a new bucket account card and/or received printed receipts for non-whole dollar change amounts owed to the customer.

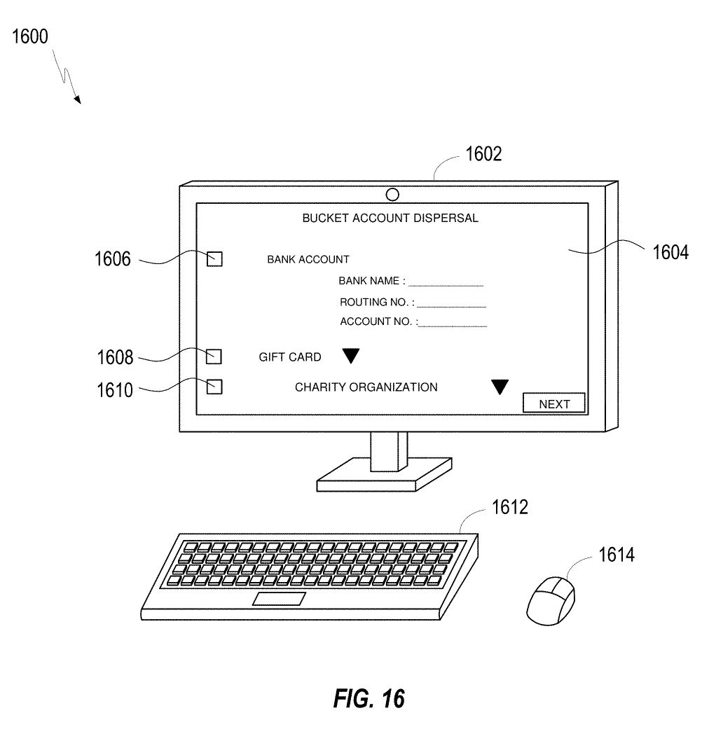

FIG. 16 is a perspective view of components 1600 that can be used by a customer to dispense funds stored in an account for collecting non-whole dollar change in accordance with one embodiment of the disclosure. The components 1600 include a monitor/CPU 1602 for displaying a customer account funds dispersal screen 1604 for a bucket system bank (e.g., bucket account registration screen). This dispersal screen 1604 may be available at a website for the bucket system. The dispersal screen information includes a first option 1606 for dispensing funds to a bank account, a second option 1608 for dispensing funds to a gift card, and a third option 1610 for dispensing funds to a charity.

The components 1600 further include a keyboard 1612 and mouse 1614 for entering information associated with identifying the customer and customer preferences. In other embodiments, additional input devices can be coupled to the monitor/CPU 1602.

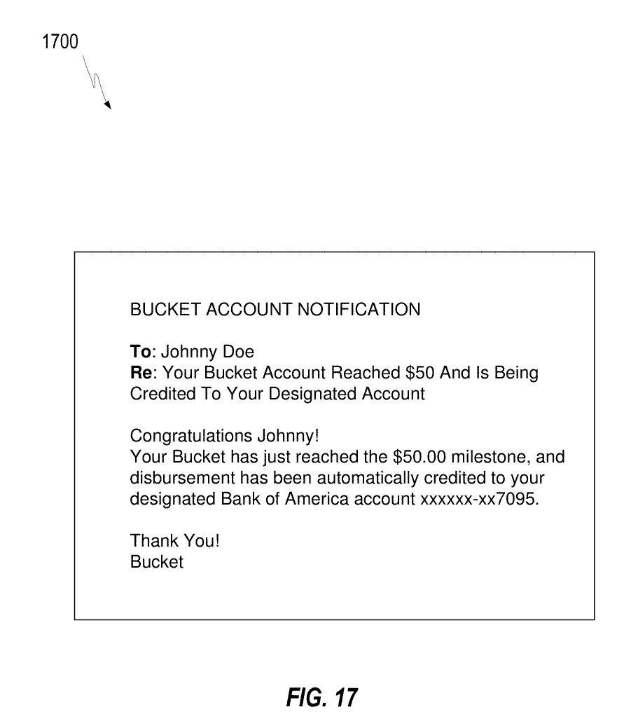

FIG. 17 is a top view of a notification 1700 to a customer that funds stored in his account for collecting non-whole dollar change will be disbursed in accordance with one embodiment of the disclosure. Notification 1700 shows a sample electronic mail (email) message sent to a customer upon dispersal of a pre-selected amount (e.g. $50) from his/her account. In another aspect, the message might include, “Dear XXX, your account has reached $50 amount, and this amount has been transferred into your checking account with the last four digits being XXXX per your instruction. Thanks and Continue bucketing to be GREEN!” In one aspect, an alternative version of the message can be sent via regular mail: “Dear XXX, your account has reached $50 amount, and this amount has been issued in a gift card enclosed. Thanks and Continue bucketing to be GREEN!” In one aspect, another alternative version can be sent via email: “Dear XXX, your account has reached $50 amount, and this amount has been transferred into your preferred charity organization ABC. Thanks and Continue bucketing to be GREEN!” In addition to the example notifications/messages, any number of other suitable messages may be used that communicate an amount to be credited to the customer's bank account.

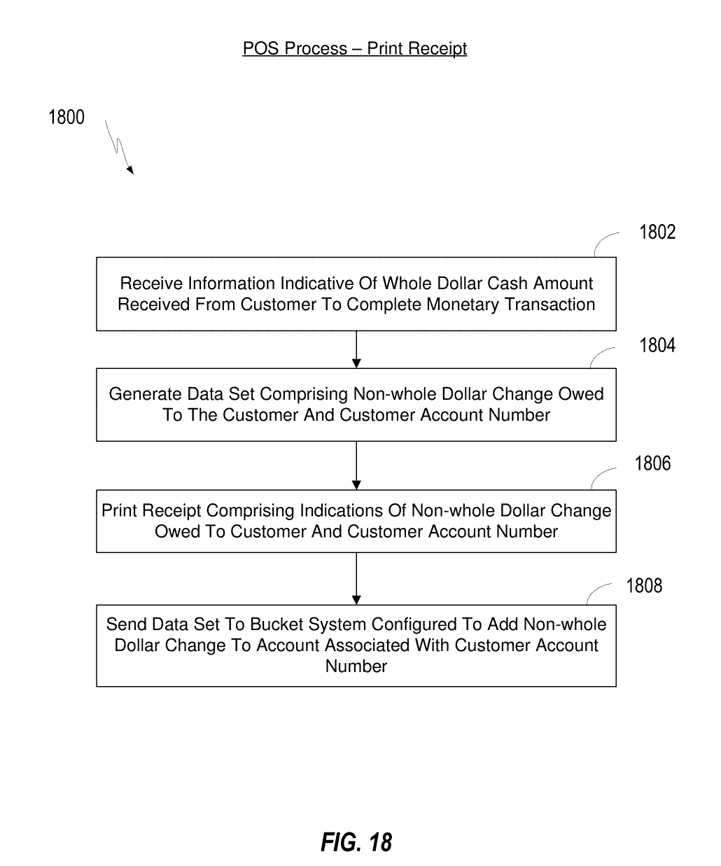

FIG. 18 is a flow chart illustrating a process 1800 for crediting a customer account with non-whole dollar change from cash based monetary transactions at a point of sale device including printing a receipt in accordance with one embodiment of the disclosure. In one aspect, the process may be performed by the point of sale (POS) device 106 of FIG. 1 or POS 504 of FIG. 5. At block 1802, the process receives information indicative of a whole dollar cash amount received from the customer to complete the monetary transaction. At block 1804, the process generates a data set comprising a non-whole dollar change owed to the customer and a customer account number. At block 1806, the process prints a receipt comprising indications of the non-whole dollar change owed to the customer and the customer account number. At block 1808, the process sends the data set to a bucket system configured to add the non-whole dollar change to an account associated with the customer account number.

In one aspect, the bucket system can add the non-whole dollar change to an account associated with the customer account number when the customer visits a website providing a software interface enabling the customer to redeem the non-whole dollar change to an existing account or to a new account. Prior to the customer visiting the website, the non-whole dollar change can be stored in a general bucket system account. In one aspect, the process may further perform any of the additional actions performed by the bucket system that are described herein.

FIG. 19 is a flow chart illustrating a process 1900 for crediting a customer account with non-whole dollar change from cash based monetary transactions in accordance with one embodiment of the disclosure. In one aspect, the process 1900 can be performed by components of the transaction system 104, including, for example, the POS 106, the payment processor 116, and/or the bucket system 120 of FIG. 1. In one aspect, the process 1900 can be performed by components of the system of FIG. 5, including, for example, the POS 504, the payment processor 510, and/or the bucket system (514, 516, 518). At block 1902, the process receives, at a retailer, information indicative of a whole dollar cash amount received from a customer to complete a monetary transaction. In one aspect, block 1902 can be performed by POS 504. At block 1904, the process generates a data set comprising a non-whole dollar change owed to the customer. In one aspect, block 1904 can be performed by POS 504. At block 1906, the process debits a bank of the retailer in an amount of the non-whole dollar change. In one aspect, block 1906 can be performed by payment processor 510 (or possibly by in-house payment processor 506). At block 1908, the process provides a first software interface for the customer to redeem the non-whole dollar change to a customer account for the customer. In one aspect, block 1908 can be performed by a bucket system (e.g., bucket system bank 514, bucket customer accounts 516, bucket system server 518).

In one aspect, the process also provides a second software interface for the customer to withdraw a portion of a total of the customer account. In such case, the process may credit a second bank (e.g., bucket system bank) in the amount of the non-whole dollar change, where providing the second software interface for the customer to withdraw the portion of the total of the customer account includes providing the second software interface for the customer to withdraw the portion of the total of the customer account, and crediting an account of the customer at a third bank (e.g., customer's bank) with the portion. In one aspect, the process can further include dispensing the portion to the customer when the total exceeds a preselected threshold amount.

In some aspects, the process may use linkage information to determine a customer account number at the point of sale device. For example, the process can receive a linkage information from the customer, where the linkage information is configured to enable the non-whole dollar change to be linked to the customer account. In such case, the process can determine a customer account number for the customer account using the linkage information. The linkage information may include a password, a customer birthday, a customer telephone, a symbol, another unique number, or any combination of these. In such case, the process (in block 1904) can generate the data set to include both the non-whole dollar change owed to the customer and the customer account number. In such case, the process (in block 1908) can provide the first software interface for the customer to redeem the non-whole dollar change to the customer account for the customer, receive the data set, and credit the customer account with the non-whole dollar change using the customer account number, where the customer account corresponds to the customer account number.

In some aspects, the process may use linkage information to determine a customer account number at the bucket system. For example, the process can receive a linkage information from the customer, wherein the linkage information is configured to enable the non-whole dollar change to be linked to the customer account. In such case, the process can determine a customer account number for the customer account using the linkage information. In such case, the process (in block 1904) can generate the data set to include both the non-whole dollar change owed to the customer and the linkage information. In such case, the process (in block 1908) can provide the first software interface for the customer to redeem the non-whole dollar change to the customer account for the customer, receive the data set, determine a customer account number for the customer account using the linkage information, and crediting the customer account with the non-whole dollar change using the customer account number, where the customer account corresponds to the customer account number.

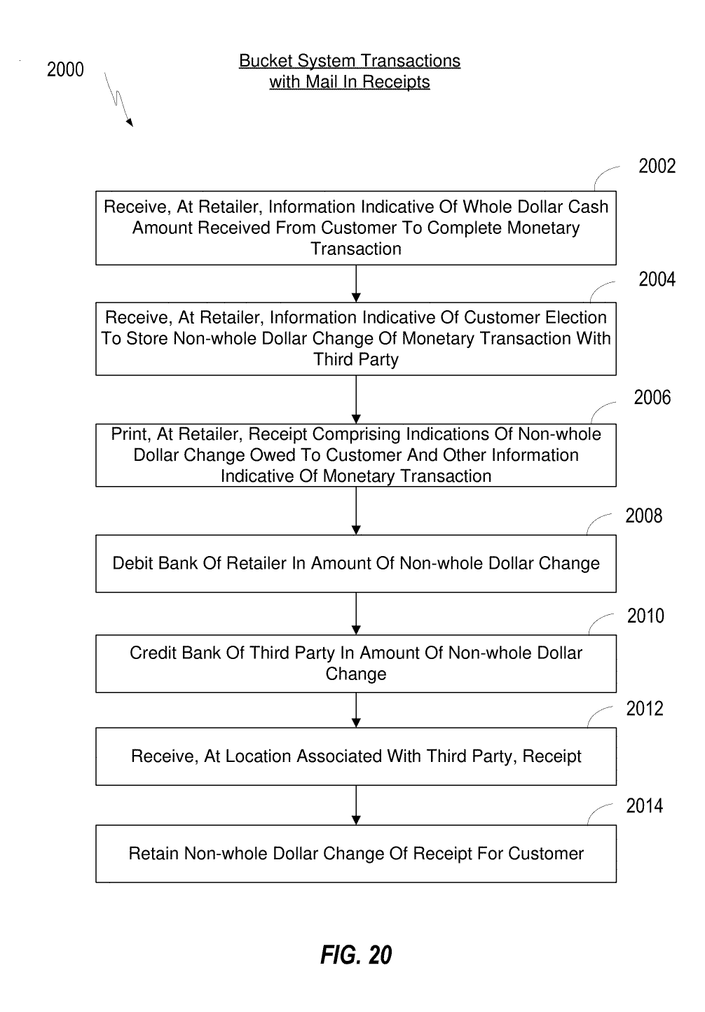

FIG. 20 is a flow chart illustrating a process 2000 for enabling a customer to redeem non-whole dollar change from cash based monetary transactions from a third party (e.g., bucket system) in accordance with one embodiment of the disclosure. In one aspect, the process 2000 can be performed by components of the transaction system 104, including, for example, the POS 106, the payment processor 116, and/or the bucket system 120 of FIG. 1. In one aspect, the process 2000 can be performed by components of the system of FIG. 5, including, for example, the POS 504, the payment processor 510, and/or the bucket system (514, 516, 518). At block 2002, the process receives, at a retailer, information indicative of a whole dollar cash amount received from a customer to complete a monetary transaction. At block 2004, the process receives, at the retailer, information indicative of an election of the customer to store a non-whole dollar change of the monetary transaction with a third party. In one aspect, the third party is a bucket system such as those described above for FIGS. 1 and 5.

At block 2006, the process prints, at the retailer, a receipt comprising indications of the non-whole dollar change owed to the customer and other information indicative of the monetary transaction. At block 2008, the process debits a bank of the retailer in an amount of the non-whole dollar change. At block 2010, the process credits a bank of the third party in an amount of the non-whole dollar change. In one aspect, the bank of the third party is a bucket system bank such as 514 in FIG. 5. In one aspect, the actions of blocks 2008 and 2010 can be performed by a payment processor such as either of those depicted in FIG. 5. At block 2012, the process receives, at a location associated with the third party, the receipt. In one aspect, the third party location can be a business configured to receive bucket system transaction receipts for the purpose of enabling the customer to redeem the non-whole dollar change of various monetary transactions. At block 2014, the process retains the non-whole dollar change of the receipt for the customer.

In one aspect, the process also disburses funds stored for the benefit of the customer. In such case, the process receives a second receipt comprising indications of a non-whole dollar change owed to the customer for a second monetary transaction and other information indicative of the second monetary transaction, generates a total of the non-whole dollar change of the first receipt and the second receipt, and disburses a portion of a total to the customer. In one aspect, the portion is disbursed when the total exceeds a preselected amount. In one aspect, the process may receive a dispersal channel specified by the customer. In such case, the process can disburse the portion via the dispersal channel. The dispersal channel may be a bank account of the customer, a gift card, a donation to a preselected charity, or a combination of these channels.

In one aspect, the process receives the first and second receipts and the dispersal channel information via a postal system (e.g., such as the U.S. Postal Service).

In one aspect, the other information indicative of the monetary transaction can include information such as an identifier of a store of the retailer where the monetary transaction occurred, a time for the monetary transaction, a date for the monetary transaction, other transaction related information, and/or combinations thereof.

As to any of the processes described above, in one embodiment, the process can perform the sequence of actions in a different order. In another embodiment, the process can skip one or more of the actions. In other embodiments, one or more of the actions are performed simultaneously. In some embodiments, additional actions can be performed.

Many aspects are described in terms of sequences of actions to be performed by, for example, elements of a computing device (e.g., bucket system server 518 or POS 504). It will be recognized that various actions described herein can be performed by specific circuits, for example, central processing units (CPUs), graphic processing units (GPUs), digital signal processors (DSPs), application specific integrated circuits (ASICs), field programmable gate arrays (FPGAs), or various other types of general purpose or special purpose processors or circuits, by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

While the above description contains many specific embodiments of the invention, these should not be construed as limitations on the scope of the invention, but rather as examples of specific embodiments thereof. Accordingly, the scope of the invention should be determined not by the embodiments illustrated, but by the appended claims and their equivalents.

The various features and processes described above may be used independently of one another, or may be combined in various ways. All possible combinations and sub-combinations are intended to fall within the scope of this disclosure. In addition, certain method, event, state or process blocks may be omitted in some implementations. The methods and processes described herein are also not limited to any particular sequence, and the blocks or states relating thereto can be performed in other sequences that are appropriate. For example, described tasks or events may be performed in an order other than that specifically disclosed, or multiple may be combined in a single block or state. The example tasks or events may be performed in serial, in parallel, or in some other suitable manner. Tasks or events may be added to or removed from the disclosed example embodiments. The example systems and components described herein may be configured differently than described. For example, elements may be added to, removed from, or rearranged compared to the disclosed example embodiments.

What is claimed is:

1. A system for crediting a customer account with change from cash based monetary transactions to avoid disbursing non-whole dollar change, the system comprising:
a point of sale device configured to:
receive, at a retailer, information indicative of a whole dollar cash amount received from a customer to complete a monetary transaction,
read a customer account number from a customer account indicating device, wherein the customer account indicating device is a read-only device, and
generate a data set comprising a non-whole dollar change owed to the customer and the customer account number;
a payment processor configured to:
debit a bank of the retailer in an amount of the non-whole dollar change, and
credit a customer account corresponding to the customer account number in the amount of the non-whole dollar change; and
a bucket system configured to:
provide a software interface enabling the customer to withdraw a portion of a total of the customer account, and
dispense the portion to the customer.

2. The system of claim 1, wherein the point of sale device is further configured to send the data set to the payment processor.

3. The system of claim 1, wherein the bucket system is further configured to deposit the amount of the non-whole dollar change into the customer account.

4. The system of claim 1, wherein the bucket system is further configured to dispense the portion to the customer when the total exceeds a preselected threshold amount.

5. The system of claim 1, wherein the customer account indicating device is selected from the group consisting of a device with a bar code, a device with a magnetic stripe, a device with a QR code, a device with a radio frequency identification (RFID) circuit, a device with an integrated circuit, and combinations thereof.

6. The system of claim 1, wherein the customer account indicating device has previously been associated with the customer attempting to complete the monetary transaction.

7. The system of claim 1, wherein the customer account indicating device has not previously been associated with the customer attempting to complete the monetary transaction.

8. The system of claim 7, wherein the software interface is configured to enable the customer to deposit a balance associated with the customer account indicating device to the customer account after the monetary transaction.

9. The system of claim 1, wherein the data set further comprises information selected from the group consisting of a transaction amount, a retail store identifier, a transaction date, a transaction time, and combinations thereof.

10. A method for crediting a customer account with change from cash based monetary transactions to avoid disbursing non-whole dollar change, the method comprising:
receiving, at a retailer, information indicative of a whole dollar cash amount received from a customer to complete a monetary transaction;
reading a customer account number from a customer account indicating device, wherein the customer account indicating device is a read-only device;
generating a data set comprising a non-whole dollar change owed to the customer and the customer account number;
debiting a bank of the retailer in an amount of the non-whole dollar change;
crediting a customer account corresponding to the customer account number in the amount of the non-whole dollar change; and
providing a software interface for the customer to withdraw a portion of a total of the customer account.

11. The method of claim 10, further comprising dispensing the portion to the customer when the total exceeds a preselected threshold amount.

12. The method of claim 10, wherein the customer account indicating device is selected from the group consisting of a device with a bar code, a device with a magnetic stripe, a device with a QR code, a device with a radio frequency identification (RFID) circuit, a device with an integrated circuit, and combinations thereof.

13. The method of claim 10, wherein the customer account indicating device has previously been associated with the customer attempting to complete the monetary transaction.

14. The method of claim 10, wherein the customer account indicating device has not previously been associated with the customer attempting to complete the monetary transaction.

15. The method of claim 14, wherein the software interface is configured to enable the customer to deposit a balance associated with the customer account indicating device to the customer account after the monetary transaction.

16. The method of claim 10, wherein the data set further comprises information selected from the group consisting of a transaction amount, a retail store identifier, a transaction date, a transaction time, and combinations thereof.

17. A method for conducting a monetary transaction wherein a customer is owed change at a point of sale (POS), the method comprising:
receiving information indicative of a whole dollar cash amount received from the customer to complete the monetary transaction;
reading a customer account number from a customer account indicating device, wherein the customer account indicating device is a read-only device;
generating a data set comprising a non-whole dollar change owed to the customer and the customer account number; and
sending the data set to a bucket system configured to add the non-whole dollar change to an account associated with the customer account number.

18. A method for conducting a monetary transaction wherein a customer is owed change at a point of sale (POS), the method comprising:
receiving information indicative of a whole dollar cash amount received from the customer to complete the monetary transaction;
generating a data set comprising a non-whole dollar change owed to the customer and a customer account number;
printing a receipt comprising indications of the non-whole dollar change owed to the customer and the customer account number; and
sending the data set to a bucket system configured to add the non-whole dollar change to an account associated with the customer account number.

19. A system for crediting a customer account with change from cash based monetary transactions to avoid disbursing non-whole dollar change, the system comprising:
a bucket system configured to:
receive an amount corresponding to a non-whole dollar change of a prior monetary transaction between a retailer and a customer at a location of the retailer;
credit the amount to a customer account for the customer;
provide a software interface enabling the customer to automatically withdraw a preselected portion of a total of the customer account; and
dispense the preselected portion to the customer.

20. A method for enabling a customer to redeem non-whole dollar change from cash based monetary transactions to avoid disbursing non-whole dollar change, the method comprising:
receiving, at a retailer, information indicative of a whole dollar cash amount received from a customer to complete a monetary transaction;
generating a data set comprising a non-whole dollar change owed to the customer;
debiting a bank of the retailer in an amount of the non-whole dollar change; and
providing a first software interface for the customer to redeem the non-whole dollar change to a customer account for the customer.

21. The method of claim 20, further comprising providing a second software interface for the customer to withdraw a portion of a total of the customer account.

22. The method of claim 21:
wherein the debiting the bank of the retailer in the amount of the non-whole dollar change comprises:
debiting the bank of the retailer in the amount of the non-whole dollar change; and
crediting a second bank in the amount of the non-whole dollar change; and
wherein the providing the second software interface for the customer to withdraw the portion of the total of the customer account comprises:
providing the second software interface for the customer to withdraw the portion of the total of the customer account; and
crediting an account of the customer at a third bank with the portion.

23. The method of claim 21, further comprising dispensing the portion to the customer when the total exceeds a preselected threshold amount.

24. The method of claim 20, further comprising:
receiving a linkage information from the customer, wherein the linkage information is configured to enable the non-whole dollar change to be linked to the customer account;
determining a customer account number for the customer account using the linkage information;
wherein the generating the data set comprising the non-whole dollar change owed to the customer comprises generating the data set comprising the non-whole dollar change owed to the customer and the customer account number; and
wherein the providing the first software interface for the customer to redeem the non-whole dollar change to the customer account for the customer comprises:
providing the first software interface for the customer to redeem the non-whole dollar change to the customer account for the customer;
receiving the data set; and
crediting the customer account with the non-whole dollar change using the customer account number, wherein the customer account corresponds to the customer account number.

25. The method of claim 20, further comprising:
receiving a linkage information from the customer, wherein the linkage information is configured to enable the non-whole dollar change to be linked to the customer account;
wherein the generating the data set comprising the non-whole dollar change owed to the customer comprises generating the data set comprising the non-whole dollar change owed to the customer and the linkage information; and
wherein the providing the first software interface for the customer to redeem the non-whole dollar change to the customer account for the customer comprises:
providing the first software interface for the customer to redeem the non-whole dollar change to the customer account for the customer;
receiving the data set;
determining a customer account number for the customer account using the linkage information; and
crediting the customer account with the non-whole dollar change using the customer account number, wherein the customer account corresponds to the customer account number.

26. The method of claim 20, further comprising:
printing a receipt comprising indications of the non-whole dollar change owed to the customer and other information indicative of the monetary transaction, wherein the other information comprises information selected from the group consisting of a transaction amount, a retail store identifier, a transaction identifier, a transaction date, a transaction time, and combinations thereof.

27. The method of claim 26:
wherein the data set further comprises a flag and the other information indicative of the monetary transaction, wherein the flag is indicative of an absence of a customer account number; and
the method further comprising scanning the receipt to redeem the non-whole dollar change owed to the customer to the customer account.

28. A method for enabling a customer to redeem non-whole dollar change from cash based monetary transactions to avoid disbursing non-whole dollar change, the method comprising:
receiving, at a retailer, information indicative of a whole dollar cash amount received from a customer to complete a monetary transaction;
receiving, at the retailer, information indicative of an election of the customer to store a non-whole dollar change of the monetary transaction with a third party;
printing, at the retailer, a receipt comprising indications of the non-whole dollar change owed to the customer and other information indicative of the monetary transaction;
debiting a bank of the retailer in an amount of the non-whole dollar change;
crediting a bank of the third party in an amount of the non-whole dollar change;
receiving, at a location associated with the third party, the receipt; and
retaining the non-whole dollar change of the receipt for the customer.

29. The method of claim 28, further comprising:
receiving a second receipt comprising indications of a non-whole dollar change owed to the customer for a second monetary transaction and other information indicative of the second monetary transaction;
generating a total of the non-whole dollar change of the first receipt and the second receipt; and
disbursing a portion of a total to the customer.

30. The method of claim 29, further comprising receiving a dispersal channel information from the customer;
wherein the disbursing the portion of the total to the customer comprises disbursing the portion of the total to the customer via the dispersal channel.

31. The method of claim 30, wherein the dispersal channel is selected from the group consisting of a bank account of the customer, a gift card, and a donation to a preselected charity.

32. The method of claim 30, wherein the first and second receipts and the dispersal channel information are received via a postal system.

33. The method of claim 29, further comprising receiving a preselected threshold amount from the customer;
wherein the disbursing the portion of the total to the customer comprises disbursing the portion of the total to the customer when the total exceeds the preselected threshold amount.

34. The method of claim 28, wherein the other information indicative of the monetary transaction comprises information selected from the group consisting of an identifier of a store of the retailer where the monetary transaction occurred, a time and date for the monetary transaction, and combinations thereof.

35. A system for crediting a customer account with change from cash based monetary transactions to avoid disbursing non-whole dollar change, the system comprising:
means for receiving, at a retailer, information indicative of a whole dollar cash amount received from a customer to complete a monetary transaction;
means for reading a customer account number from a customer account indicating device, wherein the customer account indicating device is a read-only device;
means for generating a data set comprising a non-whole dollar change owed to the customer and the customer account number;
means for debiting a bank of the retailer in an amount of the non-whole dollar change;
means for crediting a customer account corresponding to the customer account number in the amount of the non-whole dollar change; and
means for enabling the customer to withdraw a portion of a total of the customer account.
